(19) United States
(12) Patent Application Publication
(10) Pub. No.: US 2010/0179755 A1
(43) Pub. Date: Jul. 15, 2010

(54) MAP INFORMATION PROCESSING APPARATUS

(76) Inventors: Atsushi Kohno, Tokyo (JP); Fumitaka Satou, Tokyo (JP); Yuta Kawana, Tokyo (JP); Kiyoshi Matsutani, Tokyo (JP); Tomoya Ikeuchi, Tokyo (JP); Mitsuo Shimotani, Tokyo (JP); Norihiro Nishiuma, Tokyo (JP)

Correspondence Address: BIRCH STEWART KOLASCH & BIRCH, PO BOX 747, FALLS CHURCH, VA, 22040-0747, US

(21) Appl. No.: 12/376,589

(22) PCT Filed: Jun. 5, 2007
(86) PCT No.: PCT/JP2007/061387

§ 371 Date: Feb. 6, 2009

(30) Foreign Application Priority Data
Sep. 21, 2006 (JP) 2006-255877

(51) Int. Cl. G01C 21/26

(52) U.S. Cl. 701/208

(57) ABSTRACT

A map information processing apparatus includes: a new road detecting unit (19) for, when information about a road corresponding to a position detected does not exist in road information, detecting the road as a new road, and generating new road running history information showing a history of running along the detected new road; a new road generating unit (20) for generating new road information from the new road running history information generated by the new road detecting unit; a new road information storage unit (16b) for storing the new road information generated by the new road generating unit; a new road editing unit (23) for editing new road information acquired from the new road information storage unit; and a road information updating unit (21) for updating the road information by adding the new road information edited by the new road editing unit to the map information storage unit.

### FIELD OF THE INVENTION

The present invention relates to a map information processing apparatus which processes map information. More particularly, it relates a technology of detecting a new road and then incorporating this new road in the map information.

### BACKGROUND OF THE INVENTION

Conventionally, a navigation apparatus mounted in a vehicle has been known. A map information processing apparatus built in this navigation apparatus displays a map on a display unit on the basis of map information which is stored therein beforehand. Because the driver can operate the vehicle while checking the position of the vehicle by looking at the map displayed on this display unit, the driver can arrive at his or her destination surely in a short time without losing one's path.

As such a navigation apparatus, a navigation apparatus which, when a vehicle runs along a road whose information does not exist in map information held thereby, detects a new road from a running history, and adds the new road to the map information held thereby or updates the map information is known (for example, refer to patent reference 1). This navigation apparatus performs a process of connecting the start point and the endpoint of the detected new road to an existing road whose information is included in the map information stored therein on the basis of the running history of the vehicle.

[Patent reference 1] JP,2002-243469,A

However, in the navigation apparatus shown in above-mentioned patent reference 1, the map information stored therein has a deviation from the actual position because of the process of creating the map information. Furthermore, an error is included in the position information acquired by a GPS (Global Positioning System) antenna mounted in the navigation apparatus. Therefore, the use of the technology described in above-mentioned patent reference 1 may produce a deviation between the positions of the start point and the end point of a new road and their actual positions. As a result, the navigation apparatus may enter a state in which it provides an abnormal route guidance. A problem with the technology is therefore that at the worst, the navigation apparatus displays a new road which is connected to an existing road different from the one to which the new road is actually connected, and performs a route guidance.

The present invention is made in order to solve the above-mentioned problem, and it is therefore an object of the present invention to provide a map information processing apparatus which enables both a normal display of a map and a route guidance.

### DISCLOSURE OF THE INVENTION

In order to solve the above-mentioned problems, a map information processing apparatus in accordance with the present invention includes: a position detecting means for detecting a position thereof; a map information storage unit for storing map information including road information; a new road detecting unit for, when a road corresponding to the position detected by the position detecting means does not exist in the road information acquired from the map information storage unit, detecting, as a new road, the road, and generating new road running history information showing a history of running along the detected new road; a new road generating unit for generating new road information on a basis of the new road running history information generated by the new road detecting unit; a new road information storage unit for storing the new road information generated by the new road generating unit; a new road editing unit for editing new road information acquired from the new road information storage unit; and a road information updating unit, for updating the road information by adding the new road information edited by the new road editing unit to the map information storage unit.

Because the map information processing apparatus in accordance with the present invention is constructed in such a way as to edit the new road information generated on the basis of the detected new road, when, for example, there is a deviation between the actual positions of the start point and the end point of the new road and the positions of the start point and the end point on the road map, the map information processing apparatus can correct the deviation. As a result, the map information processing apparatus makes it possible to produce a normal display of a map and provide a route guidance.

### BRIEF DESCRIPTION OF THE FIGURES

FIG. 1 is a block diagram showing the structure of a map information processing apparatus in accordance with Embodiment 1 of the present invention;

FIG. 2 is a view showing an image in which a navigation apparatus which constructs the map information processing apparatus in accordance with Embodiment 1 of the present invention runs along a new road;

FIG. 3 is a block diagram showing only components used for a new road detection process which are extracted from all the components of the navigation apparatus shown in FIG. 1;

FIG. 4 is a flow chart showing the details of the new road detection process carried out by the map information processing apparatus in accordance with Embodiment 1 of the present invention;

FIG. 5 is a view showing an example of new road information for use in the map information processing apparatus in accordance with Embodiment 1 of the present invention;

FIG. 6 is a flow chart showing a connection judging process carried out by the map information processing apparatus in accordance with Embodiment 1 of the present invention;

FIG. 7 is an explanatory drawing for explaining the connection judging process carried out by the map information processing apparatus in accordance with Embodiment 1 of the present invention;

FIG. 8 is a block diagram showing only components used for a new road editing process which are extracted from all the components of the navigation apparatus shown in FIG. 1;

FIG. 9 is a flow chart showing the details of the new road editing process carried out by the map information processing apparatus in accordance with Embodiment 1 of the present invention;

FIG. 10 is a view showing an example of update of new road information which is performed by the map information processing apparatus in accordance with Embodiment 1 of the present invention;

FIG. 11 is a view showing another example of the editing performed in the new road editing processing performed by the map information processing apparatus in accordance with Embodiment 1 of the present invention;

FIG. 12 is a view showing a further example of the editing performed in the new road editing processing performed by the map information processing apparatus in accordance with Embodiment 1 of the present invention;

FIG. 13 is a view showing a still further example of the editing performed in the new road editing processing performed by the map information processing apparatus in accordance with Embodiment 1 of the present invention;

FIG. 14 is an view showing an image in which the point coordinates of a new road are added in the map information processing apparatus in accordance with Embodiment 2 of the present invention;

FIG. 15 is a flow chart showing the details of a point adding process carried out by a map information processing apparatus in accordance with Embodiment 2 of the present invention;

FIG. 16 is a view for explaining a change in new road information in the point adding process carried out in the map information processing apparatus in accordance with Embodiment 2 of the present invention;

FIG. 17 is an view showing an image in which the point coordinates of a new road are deleted in the map information processing apparatus in accordance with Embodiment 2 of the present invention;

FIG. 18 is a view for explaining a change in new road information in the point deleting process carried out in the map information processing apparatus in accordance with Embodiment 2 of the present invention;

FIG. 19 is a view for explaining another method in a case of deleting the point coordinates of a new road in the map information processing apparatus in accordance with Embodiment 2 of the present invention;

FIG. 20 is a flow chart showing the operation of a map information processing apparatus in accordance with Embodiment 3 of the present invention;

FIG. 21 is a view showing an example of an acknowledgement message displayed on the map information processing apparatus in accordance with Embodiment 3 of the present invention;

FIG. 22 is a view for explaining automatic shape correction in a map information processing apparatus in accordance with Embodiment 4 of the present invention;

FIG. 23 is a view showing an image in which the shape of a road is corrected automatically through the automatic shape correction process by the map information processing apparatus in accordance with Embodiment 4 of the present invention;

FIG. 24 is a flow chart showing the details of the automatic shape correction process carried out by the map information processing apparatus in accordance with Embodiment 4 of the present invention;

FIG. 25 is a view for explaining a variant of the automatic shape correction process carried out by the map information processing apparatus in accordance with Embodiment 4 of the present invention;

FIG. 26 is a block diagram showing the structure of a map information processing apparatus in accordance with Embodiment 5 of the present invention;

FIG. 27 is a view showing an image in which the shape of a new road is corrected according to running of a navigation apparatus which constructs the map information processing apparatus in accordance with Embodiment 5 of the present invention;

FIG. 28 is a view showing an image in which a reference point which is an object to be moved is estimated in a map information processing apparatus in accordance with Embodiment 6 of the present invention; and

FIG. 29 is a view showing an image in which the point coordinates of a movement destination is estimated in the map information processing apparatus in accordance with Embodiment 6 of the present invention.

### PREFERRED EMBODIMENTS OF THE INVENTION

Hereafter, in order to explain this invention in greater detail, the preferred embodiments which implement the present invention will be described with reference to the accompanying drawings. In the preferred embodiments shown below, the description will be made with the same elements or like elements in the various views being designated by the same reference characters.

### Embodiment 1

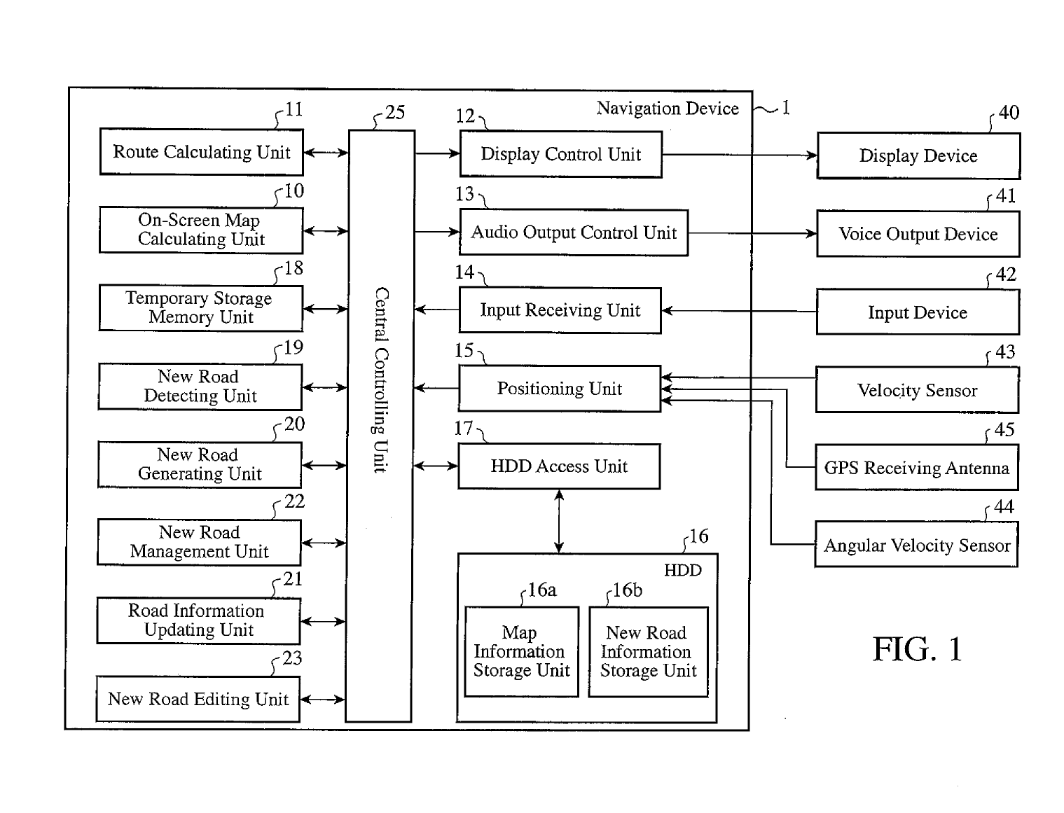

FIG. 1 is a block diagram showing the structure of a map information processing apparatus in accordance with Embodiment 1 of the present invention. This map information processing apparatus is comprised of a navigation device 1, a display device 40 connected to this navigation device 1, a voice output device 41, an input device 42, a velocity sensor 43, an angular velocity sensor 44, and a GPS receiving antenna 45.

The navigation device 1 is comprised of an on-screen map calculating unit 10, a route calculating unit 11, a display controlling unit 12, an audio output controlling unit 13, an input receiving unit 14, a positioning unit 15, an HDD (Hard Disk Drive) 16, an HDD access unit 17, a temporary storage memory unit 18, a new road detecting unit 19, a new road generating unit 20, a road information updating unit 21, a new road management unit 22, a new road editing unit 23, and a central controlling unit 25.

According to a procedure which is programmed beforehand, the central controlling unit 25 starts and stops the on-screen map calculating unit 10, the route calculating unit 11, the display controlling unit 12, the audio output controlling unit 13, the input receiving unit 14, the positioning unit 15, the HDD access unit 17, the temporary storage memory unit 18, the new road detecting unit 19, the new road generating unit 20, the new road management unit 22, the new road editing unit 23, and the road information updating unit 21, and controls transmission and reception of data among these components. Hereafter, in order to avoid the explanation from becoming complicated, the description of the fact that transmission and reception of data among the above-mentioned components are performed via the central controlling unit 25 will be omitted.

The on-screen map calculating unit 10 calculates a map image for display from map information sent thereto, via the HDD access unit 17, from a map information storage unit 16a of the HDD 16, and new road information sent thereto, via the HDD access unit 17, from a new road information storage unit 16b of the HDD 16. The map image acquired through the calculation by this on-screen map calculating unit 10 is sent to the display controlling unit 12.

The route calculating unit 11 calculates a recommended route between two arbitrary points included in either points inputted from the input receiving unit 14 or points sent thereto from the positioning unit 15 on the basis of the map information sent thereto, via the HDD access unit 17, from the map information storage unit 16a of the HDD 16. The recommended route calculated by this route calculating unit 11 is sent to the display controlling unit 12. The display controlling unit 12 converts both the map image for display which is sent thereto from the on-screen map calculating unit 10, the recommended route sent thereto from the route calculating unit 11, etc. into data in a format which can be displayed by the display unit 40, and sends them to the display unit 40. As a result, the map and the recommended route are displayed on the display unit 40.

The audio output controlling unit 13 converts both voice information with which the navigation device performs a guidance to the destination according to the recommended route sent thereto from the route calculating unit 11, and voice information with which the navigation device notifies information included in the map information to the driver into pieces of information in a format which can be outputted by the voice output device 41, and sends them to the voice output device 41. The input receiving unit 14 receives an input signal sent thereto from the input device 42, and sends it to the on-screen map calculating unit 10, the route calculating unit 11, and so on.

The positioning unit 15 corresponds to a position detecting means of the present invention. This positioning unit 15 detects the current position of itself (which means a vehicle in which the map information processing apparatus is mounted. The itself will be referred to as the vehicle from here on) on the basis of signals which are sent thereto from the velocity sensor 43, the angular velocity sensor 44, and the GPS receiving antenna 45 to generate position information, and compares the position information generated thereby with the road information stored in the HDD 16 so as to determine if the current position of the itself corresponds to which position on which one of the roads shown by the road information. When the on-screen map calculating unit 10 performs a calculation for displaying a map of an area surrounding the itself, or when the route calculating unit 11 calculates a recommended route from the current position of the itself to an input point, this positioning unit 15 sends the positioning result to either the on-screen map calculating unit 10 or the route calculating unit 11.

The HDD 16 is provided with the map information storage unit 16a for storing map information, and the new road information storage unit 16b for storing new road information. The map information including road information is stored in the map information storage unit 16a at the time of shipment of the map information processing apparatus. The new road information storage unit 16b is an area to which, when the vehicle has run along a road whose information is not included in the map information stored in the map information storage unit 16a at the time of shipment of the map information processing apparatus, new road information showing the road is added. The HDD access unit 17 controls writing and reading of data in and from the HDD 16 according to an instruction from the central controlling unit 25.

The temporary storage memory unit 18 consists of, for example, a volatile memory, and is used in order to store various pieces of information temporarily. Each component connected to the central controlling unit 25, when carrying out its process by using the map information stored in the HDD 16 and the road information about roads (referred to as “existing roads” from here on), which is included in the new road information, reads map information and new road information about a map area corresponding to a mesh which each component uses in performing the process from the HDD 16 by means of the HDD access unit 17, and stores the pieces of information which each component has read in the temporary storage memory unit 18 to use them.

The new road detecting unit 19 compares the road information included in the map information sent thereto, via the HDD access unit 17, from the map information storage unit 16a of the HDD 16 with the position information sent thereto from the positioning unit 15, detects a new road whose information does not exist in the road information included in the map information, and sends new road running history information showing the history of running along this detected new road to the new road generating unit 20.

The new road generating unit 20 generates new road information from the new road running history information sent thereto from the new road detecting unit 19, and stores the new road information in the new road information storage unit 16b. When completing the generation of the new road information, the new road generating unit 20 issues an update request to update the road information to the road information updating unit 21. In response to this update request, the road information updating unit 21 updates the map information and the road information stored in the HDD 16 on the basis of the road update information generated by the new road generating unit 20. The new road management unit 22 manages the new road information stored in the new road information storage unit 16b. The new road editing unit 23 edits the new road information according to input information received from the input receiving unit 14.

The display unit 40 connected to the navigation device 1 consists of, for example, a liquid crystal display, and displays the map, the recommended route, or the like on the basis of the map image for display or the data about the recommended route which is sent from the display controlling unit 12. The voice output device 41 consists of, for example, a speaker, outputs a voice with which the navigation device performs a guidance to the destination according to the recommended route, and also outputs information included in the map information by voice.

The input device 42 inputs a map area which the user desires to make the display unit 90 display, and a start point and an end point which the user desires for the calculation of the recommended route. This input device 42 can consist of, for example, an input button installed in a main part panel arranged in the front face of the navigation device, a remote controller (remote control) for sending an input signal equivalent to that generated by the input button, a touch panel mounted on the screen of the display unit 40, or a microphone for voice input for enabling the user to perform a voice operation, or a combination of two or more of these components.

The velocity sensor 43 detects the velocity at which the itself runs. The velocity detected by this velocity sensor 43 is sent to the positioning unit 15. The angular velocity sensor 44 detects a directional change of the itself. The directional change detected by this angular velocity sensor 44 is sent to the positioning unit 15. The GPS receiving antenna 45 receives electric waves sent from GPS satellites. The GPS signals acquired by receiving the electric waves with this GPS receiving antenna 45 are sent to the positioning unit 15.

Next, the operation of the map information processing apparatus in accordance with Embodiment 1 of the present invention which is constructed as mentioned above will be explained focusing on a new road detecting process and a new road editing process.

### (1-1) New Road Detecting Process

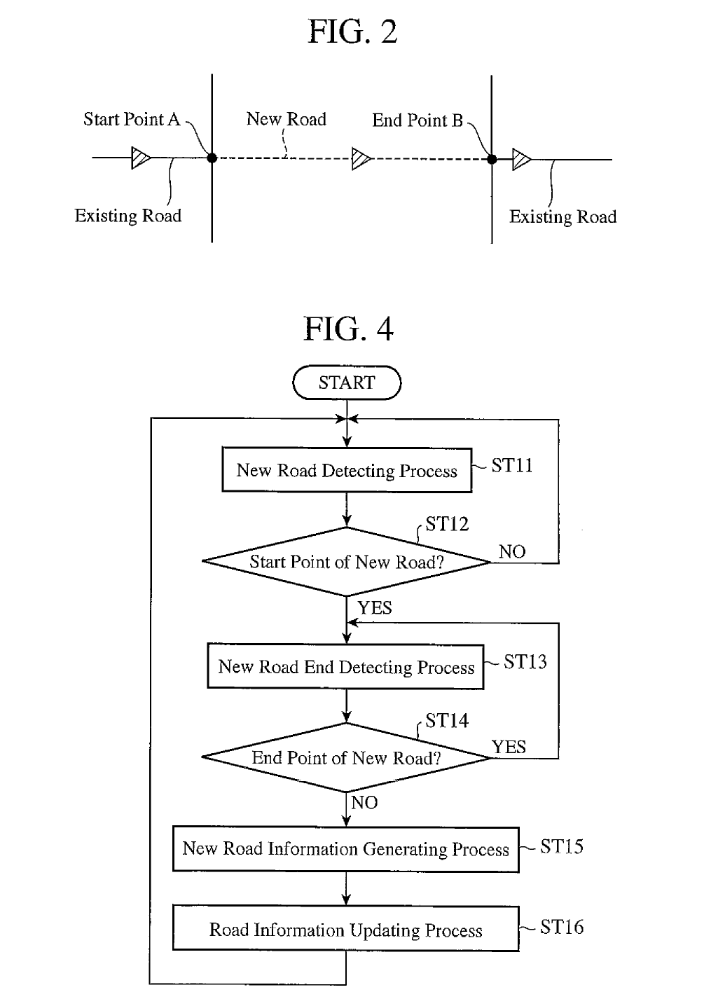

FIG. 2 is a view showing an image in which the vehicle in which the navigation device 1 is mounted runs along a new road. In FIG. 2, a start point A and an end point B are intersections on an existing road, and a road (shown by a dashed line) which connects between the intersections is detected as a new road.

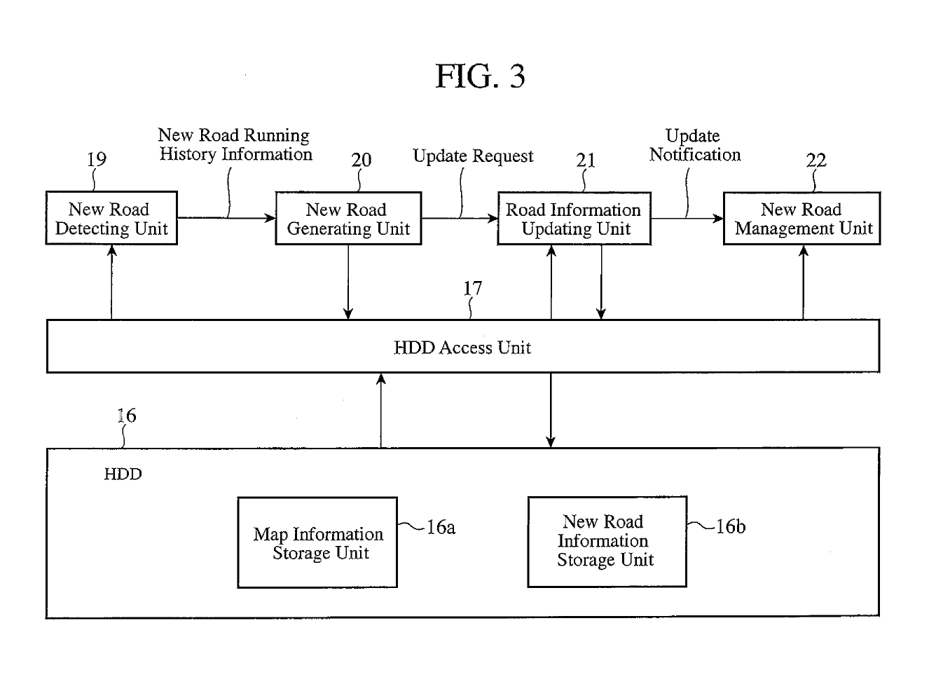

FIG. 3 is a block diagram showing only components used for the new road detecting process, which are extracted from among all the components of the navigation device 1 shown in FIG. 1, and each of the components except the HDD 16 is implemented by software processing. FIG. 4 is a flow chart showing the details of the new road detecting process. Hereafter, the details of the new road detecting process will be explained with reference to the block diagram shown in FIG. 3 and the flow chart shown in FIG. 4.

In the new road detecting process, a new road start point detecting process is performed first (step ST11). The new road detecting unit then checks to see whether the start point of a new road has been detected (step ST12). When, in this step ST12, judging that the start point of a new road has not been detected, the new road detecting unit returns the sequence to step ST11 and repeats the above-mentioned process.

In contrast, when, in step ST12, judging that the start point of a new road has been detected, the new road detecting unit then perform the new road end detecting process (step ST13). The new road end detecting process then checks to see whether the end point of the new road has been detected (step ST14). When, in this step ST14, judging that the end point of the new road has not been detected, the new road detecting unit returns the sequence to step ST13 and repeats the above-mentioned process. In contrast, when, in this step ST14, judging that the end point of the new road has been detected, the new road detecting unit advances the sequence to step ST15.

The process of judging whether or not the vehicle is running along a road whose information does not exist in the existing map information in each of the above-mentioned new road start point detecting process and the above-mentioned new road end detecting process is described in detail in, for example, JP,2006-53123,A which the applicant for this patent application applied previously. Please refer to the reference as needed.

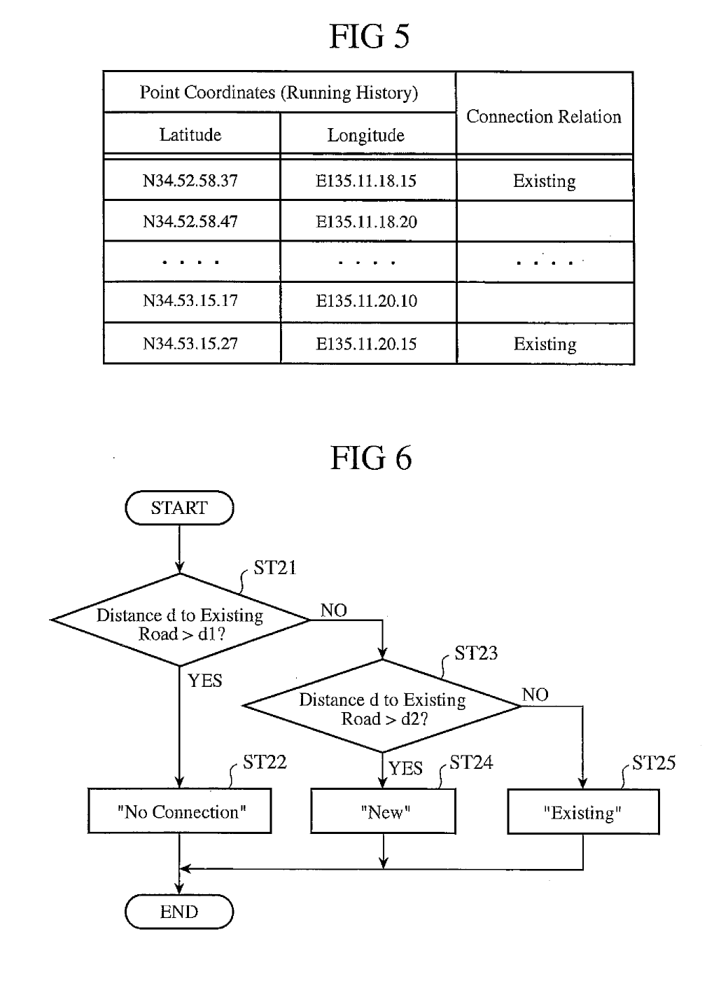

When the start point and the end point of the new road are detected through the above-mentioned process of steps ST11 to ST14, the new road generating unit then carries out a process of generating new road information (step ST15). More specifically, the new road detecting unit 19 sends the new road running history information about the history of running along the new road from the start point A to the end point B, these points being detected in the above-mentioned steps ST11 to ST14, to the new road generating unit 20. The new road running history information is comprised of, for example, a list of the coordinates of points which are spaced at predetermined time intervals between the start point A and the end point B, as shown in the column of “point coordinates (running history)” of FIG. 5.

The new road generating unit 20 performs a connection determination process of determining a connection relation, such as whether the start point and the end point shown by the new road running history information received from the new road detecting unit 19 are located in intersections of an existing road, and sets, as connection information showing the connection relation of each of the start point and the end point, either of “existing”, “new”, and “no connection.” As a result, the new road information as shown in FIG. 5 is generated.

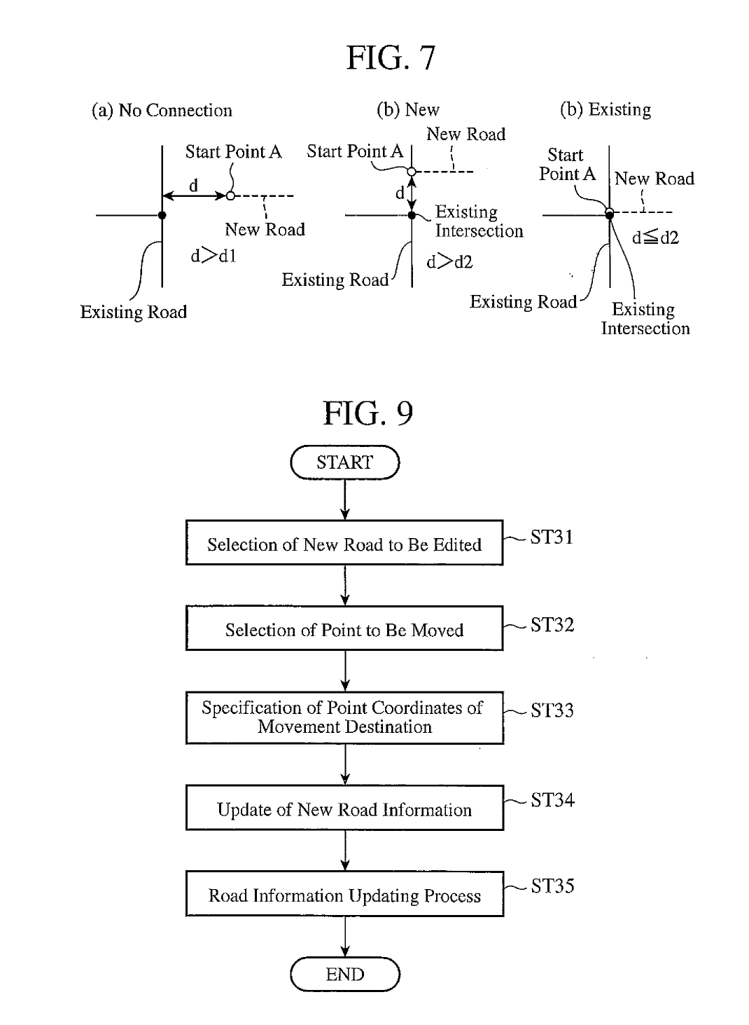

FIG. 6 is a flow chart showing the connection determination process, and FIG. 7 is an explanatory drawing for explaining the connection determination process. In this connection determination process, the new road generating unit checks to see whether or not the distance d between the start point and the existing road is longer than a predetermined value d1 first (step ST21). When, in this step ST21, judging that the distance d between the start point A and the existing road is longer than the predetermined value d1, as shown in, for example, FIG. 7(a), the new road generating unit sets up “no connection” as the connection information about the start point (step ST22).

When, in above-mentioned step ST21, judging that the distance d between the start point and the existing road is equal to or shorter than the predetermined value d1, the new road generating unit then checks to see whether or not the distance d between the start point and the existing intersection is longer than a predetermined value d2 (step ST23). When, in this step ST23, judging that the distance d between the start point A and the existing road is longer than the predetermined value d2, as shown in, for example, FIG. 7(b), the new road generating unit sets up “new” as the connection information about the start point (step ST24).

When, in above-mentioned step ST23, judging that distance d between the start point A and the existing intersection is equal to or shorter than the predetermined value d2, as shown in, for example, FIG. 7(c), the new road generating unit sets up “existing” as the connection information about the start point (step ST25). Although only the case in which the connection relation for the start point A of the new road is judged is shown in FIGS. 6 and 7, the same goes for a case of setting up a connection relation for the end point B of the new road.

The new road generating unit 20 issues an update request to update the road information to the road information updating unit 21 while writing the new road information generated as mentioned above in the new road information storage unit 16b of the HDD 16 via the HDD access unit 17.

The road information updating unit then carries out a road information updating process (step ST16). More specifically, in response to the update request from the new road generating unit 20, the road information updating unit 21 performs a map updating process of connecting the road information which is included in the existing map information with the new road information by also taking the connection information included in the new road information into consideration. Because the details of this map updating process are described in, for example, above-mentioned JP,2006-53123,A, please refer to this reference as needed.

When completing the map updating process, the road information updating unit 21 sends an update notification to the new road management unit 22. The new road management unit 22 which has received the update notification reads the updated map information (the existing map and the new road information) from the HDD 16 via the HDD access unit 17, and updates a list of new roads (not shown) which the new road management unit holds therein and manages.

In the above-mentioned new road detecting process, only the case in which the fact that the new road is connected to an intersection of an existing road is mentioned as a connection relation is explained. Also in a case in which a new intersection is generated and in a case in which the new road is not connected to any existing road, the new road detecting process is similarly performed.

In the above-mentioned new road detecting process, the new road information is generated by using the new road running history information, just as it is. As an alternative, in order to reduce the data size of the new road information, the new road information can be generated while the new road running history information is thinned out properly. In this case, if the shape of the road shown by the point coordinates is a straight line, all points (except for the end points) on the straight line can be excluded.

### (1-2) New Road Editing Process

In the new road editing process, a process of editing the new road information which is generated while being associated with the new road detected through the above-mentioned new road detecting process is carried out.

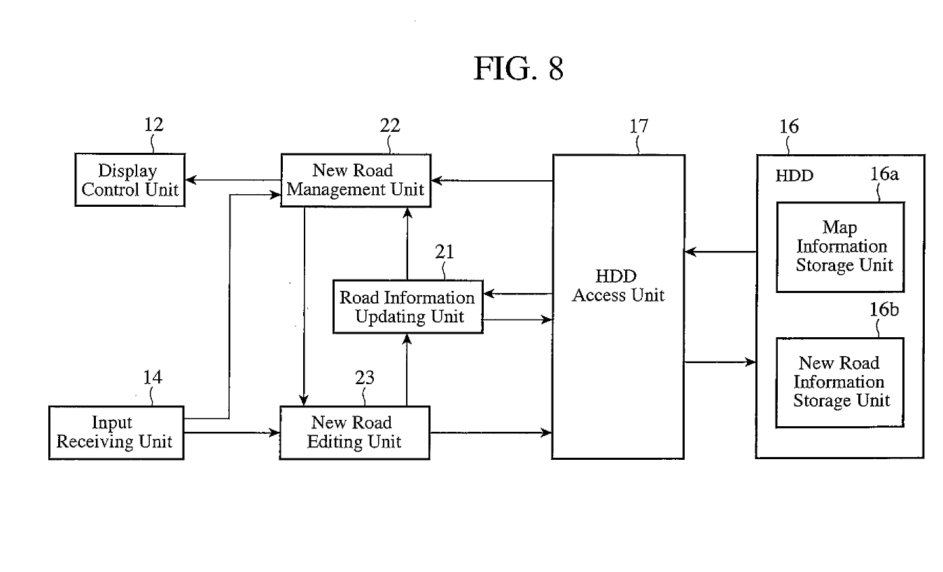

FIG. 8 is a block diagram showing only components used for the new road editing process, which are extracted from among all the components of the navigation device 1 shown in FIG. 1, and each of the components except the HDD 16 is implemented by software processing. FIG. 9 is a flow chart showing the details of the new road editing process. Hereafter, the details of the new road editing process will be explained with reference to the block diagram shown in FIG. 8 and the flow chart shown in FIG. 9.

In the new road editing process, the new road management unit selects a new road which is an object to be edited first (step ST31). Concretely, the new road management unit 22 sends the list of new roads which the new road management unit holds to the display controlling unit 12. The display controlling unit 12 converts the list of new roads sent thereto from the new road management unit 22 into a list in a format which can be displayed on the display unit 40, and sends this list to the display unit 40. As a result, the new road list is displayed on the display unit 40.

The user selects a new road which is an object to be edited from the new road list currently being displayed on the display unit 40 by using the input device 42. Selecting operation information which is generated by the input device 42 through this selecting operation done by the user is sent to the new road management unit 22 via the input receiving unit 14. The new road management unit 22 reads the new road information corresponding to the new road shown by the received selecting operation information from the new road information storage unit 16b within the HDD 16, and sends the new road information to the new road editing unit 23. The new road information read from the new road information storage unit 16b includes, as its elements, a plurality of reference points which define the new road, and the new road is shown by links of these reference points. A reference point at one end of the new road is the start point, and a reference point at the other end of the new road is the end point.

The new road management unit 22 sends the new road information read from the new road information storage unit 16b to the display controlling unit 12. The display controlling unit 12 converts the new road information sent thereto from the new road management unit 22 into information in a format which can be displayed on the display unit 40, and sends this information to the display unit 40. As a result, a map in which the new road is drawn is displayed on the display unit 40.

A selection of a point which is to be moved is then performed (step ST32). More specifically, the user specifies a point which he or she desires to move on the new road in the map currently being displayed on the display unit 40 by using the input device 42. The coordinates of this point specified by the input device 42 are sent to the new road editing unit 23 via the input receiving unit 14. Actually, the point coordinates of a reference point on the new road which is the nearest to the point specified by the user are sent to the new road editing unit 23. The input device 42 and the input receiving unit 14 which are used for selection of the point to be moved correspond to a reference-point-to-be-moved specifying means of the present invention.

The point coordinates of the destination of the movement are then specified (step ST33). More specifically, the user specifies the movement destination of the point to be moved which is selected in step ST32 by using the input device 42. The coordinates of this point specified by the input device 42 are sent to the new road editing unit 23 via the input receiving unit 14. Actually, the point coordinates of a point which is the nearest to the point specified by the user are sent to the new road editing unit 23 as the point coordinates of the movement destination. The input device 42 and the input receiving unit 14 which are used for specification of the point coordinates of the movement destination correspond to a reference-point-to-be-moved coordinate specifying means of the present invention.

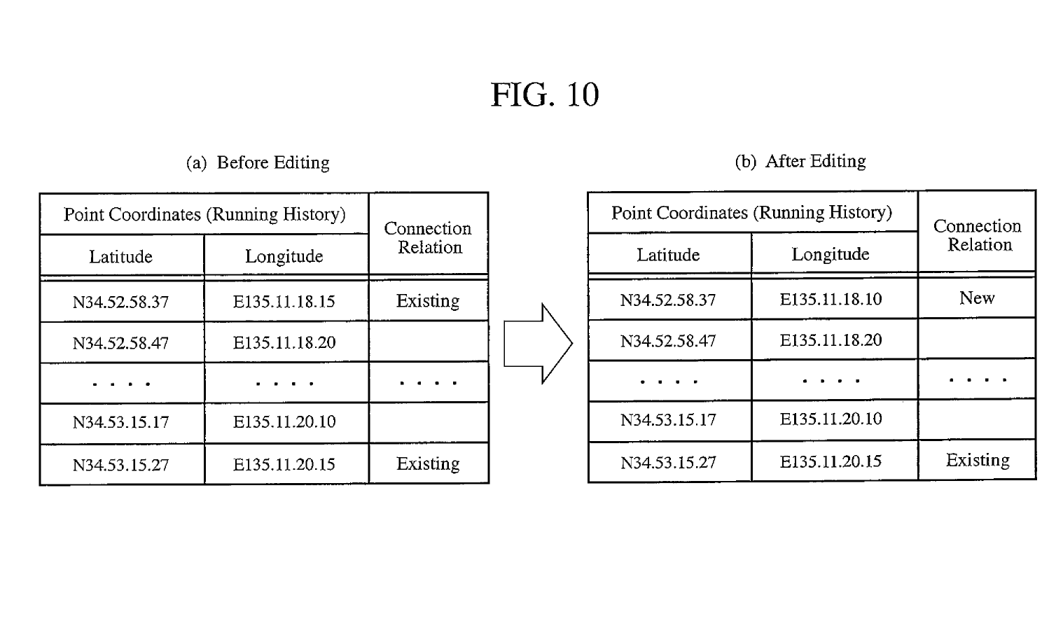

An update of the new road information is then performed (step ST34). More specifically, the new road editing unit 23 updates the new road information, as shown in, for example, FIG. 10, from the point to be moved which is selected in step ST32 and the point coordinates of the movement destination specified in step ST33, and writes the updated new road information in the new road information storage unit 16b of the HDD 16 via the HDD access unit 17. In this case, the connection relation between the point coordinates of the movement destination and an existing road is judged through the same process as the connection determination process in the above-mentioned new road detecting process, and is defined as the new road information.

The road information updating process is then performed (step ST35). More specifically, when the new road editing unit 23 completes the process of writing the new road information, the new road editing unit 23 sends an update request to update the road information to the road information updating unit 21, and the road information updating unit 21 performs the process of updating the new road information by using the same method as that used for the process performed in step ST16 of the above-mentioned new road detecting process.

Although the example in which the coordinates of the start point of a new road are moved in the above-mentioned new road editing process is explained, the candidate for the point to be moved is not limited to the start point, but can be an arbitrary point. However, in order to make the navigation function of the navigation device (e.g., the route guidance) be accurate, the positions of the start point and the endpoint are important and the frequency at which the start point and the end point are moved increases. Therefore, the map information processing apparatus can be constructed in such a way as to provide a user interface for limiting user input to the start point and the end point in a case of making the user select the candidate for the point to be moved.

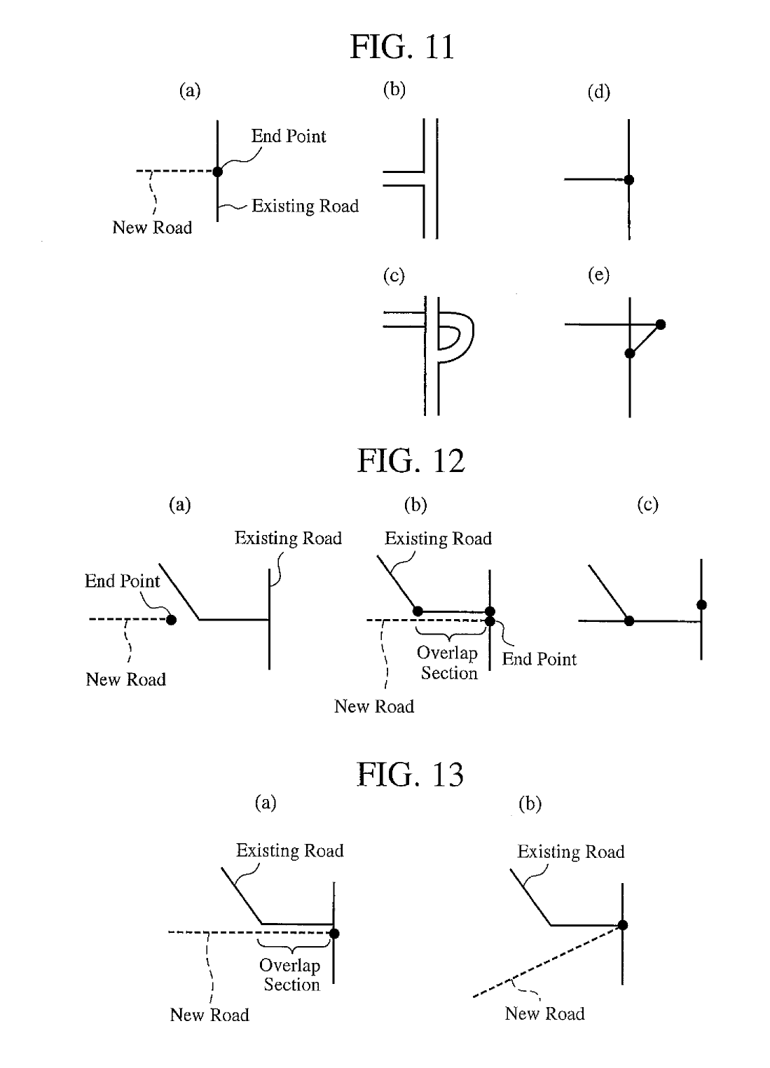

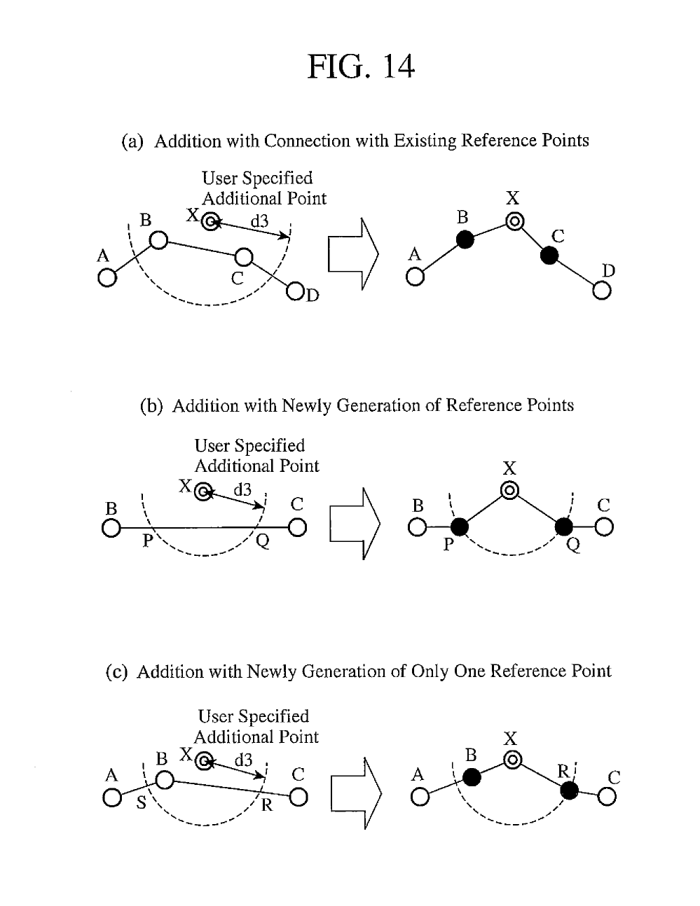

The map information processing apparatus can also be constructed in such a way as to, in the above-mentioned new road editing process, enable the user to specify a direction in which the new road is connected to an existing road at the time of moving the start point or the end point of the new road. For example, the map information processing apparatus can also be constructed in such a way as to, when there exists a new road whose end point is connected to an existing road, as shown in FIG. 11(a), enable the user to specify whether to connect the new road to either one end of the existing road or the other end of the existing road as an example of the movement of the end point. According to this structure, a distinction can be made between a case in which the new road is directly connected to an existing road from one side of the existing road, as shown in FIG. 11(b), and a case in which the new road is connected to an existing road from the opposite side of this existing road after overpassing or underpassing the existing road, as shown in FIG. 11(c). In a case in which the new road is connected to an existing road, as shown in FIG. 14(b), the road information is expressed as shown in FIG. 11(d), whereas in a case in which the new road is connected to an existing road, as shown in the FIG. 14(b), the road information is expressed as shown in FIG. 11(e).

Furthermore, the map information processing apparatus can also be constructed in such a way as to, in the above-mentioned new road editing process, after the start point or end point of the new road is moved by the user, provide traffic regulations according to the angle with which the existing road and the new road are connected to each other. For example, the map information processing apparatus can also be constructed in such a way as to, in a case in which the angle with which the vehicle enters the existing road from the new road while turning to the right is acute, prohibit right turn and grant only left turn when the vehicle enters the existing road from the new road. According to this structure, road information which matches the actual conditions of the roads can be provided.

In addition, the map information processing apparatus can also be constructed in such a way as to, in the above-mentioned new road editing process, in a case in which there exists a section in which the existing road and the new road overlap each other, remove the section of the existing road. For example, in a case in which the end point of the new road is distant from the existing road, as shown in FIG. 12(a), moving of an end point to connect it with the existing road can result in occurrence of a section in which the new road and the existing road overlap each other, as shown in FIG. 12(b). In this case, by deleting the section of the existing road in the new road editing process, road information as shown in FIG. 12(c) can be acquired. According to this structure, road information which is closer to the actual roads can be provided.

Furthermore, the map information processing apparatus can also be constructed in such a way as to, in the above-mentioned new road editing process, in a case in which there exists a section in which the existing road and the new road overlap each other, change the angle with which the existing road is connected with the new road. For example, there can be a case in which moving of an end point of the new road to connect it with the existing road results in occurrence of a section in which the new road and the existing road overlap each other, as shown in FIG. 13(a). In this case, by changing the angle with which the existing road is connected with the new road in the new road editing process, road information in which the new road is distinguished from the existing road can be acquired, as shown in FIG. 13(b). According to this structure, even in a case in which the new road and the existing road are running in parallel with each other, correct road information can be provided.

### Embodiment 2

The map information processing apparatus in accordance with above-mentioned Embodiment 1 is constructed in such a way as to edit the new road information by moving a point on the new road. In contrast, a map information processing apparatus in accordance with Embodiment 2 is constructed in such a way as to edit new road information by adding new point coordinates to a new road or deleting a point on the new road.

The structure of the map information processing apparatus in accordance with Embodiment 2 is the same as that of the map information processing apparatus in accordance with Embodiment shown in FIG. 1. Furthermore, in the map information processing apparatus in accordance with Embodiment 2, the structure for implementing the new road editing process shown in the block diagram of FIG. 8 is used. Hereafter, a point adding process of adding a reference point, and a point deleting process of deleting a reference point will be explained.

### (2-1) Point Adding Process

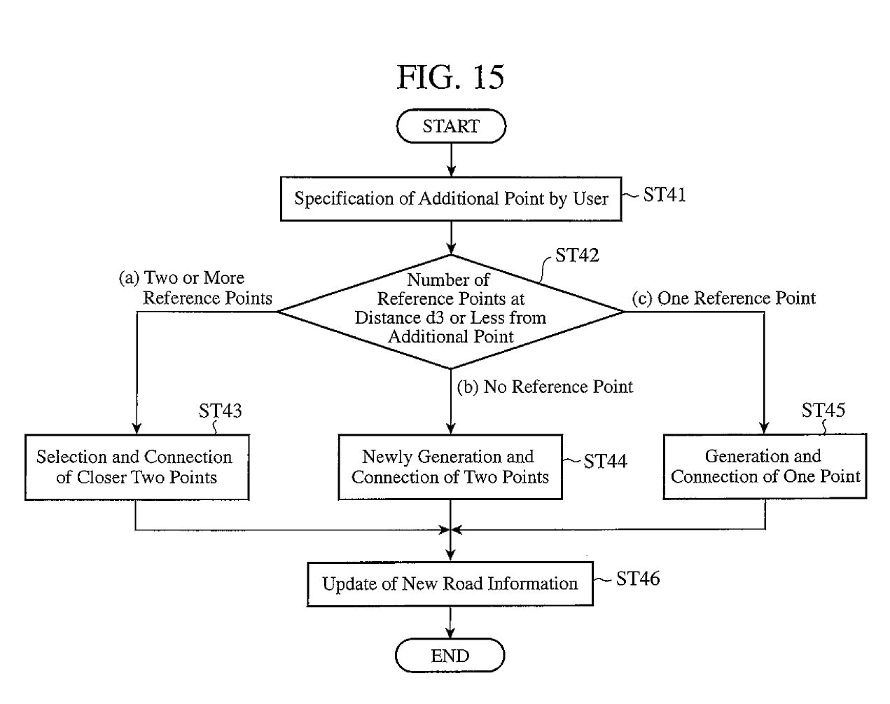

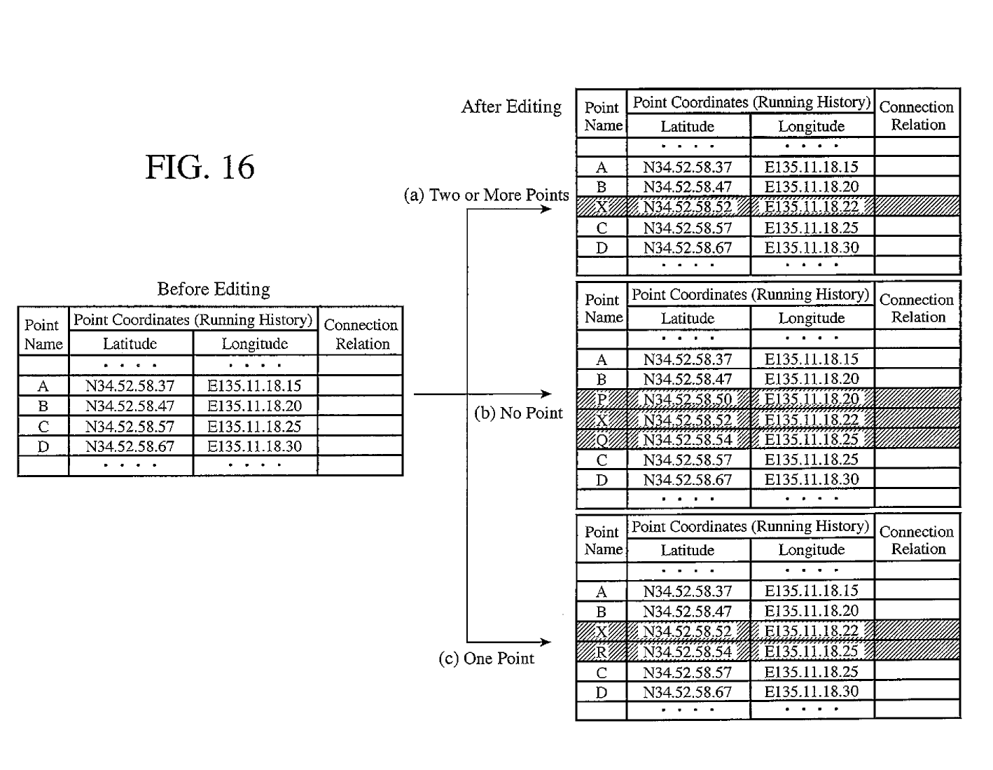

FIG. 14 is a view showing an image in which the map information processing apparatus adds the coordinates of a point to a new road by carrying out the point adding process. FIG. 15 is a flow chart showing the details of the point adding process. FIG. 16 is a view for explaining a change in the new road information which is caused by the point adding process. Hereafter, the point adding process will be explained with reference to these figures.

In the point adding process, an additional point X is specified by the user first (step ST41). More specifically, the user specifies the additional point X by using the input device 42. The coordinates of the additional point X specified by this input device 42 are sent to the new road editing unit 23 via the input receiving unit 14. The input device 42 and the input receiving unit 14 which are used for specification of the additional point correspond to an additional reference point specifying means of the present invention.

Then, the new road editing unit checks to see the number of reference points which exist in an area at a predetermined distance d3 or less from the additional point specified in step ST41 (step ST42). More specifically, the new road editing unit 23 checks to see the number of reference points on the new road which exist in the area at the predetermined distance d3 or less from the coordinates of the additional point specified in step ST41, and which are objects to be edited.

When, in this step ST42, judging that there exist two or more reference points in the area at the predetermined distance d3 or less from the additional point X, as shown in FIG. 14(a), the new road editing unit selects, from among the two or more reference points, two reference points B and C which are closer to the additional point X, and connects the selected reference points B and C with the additional point X to generate new new road information (step ST43). After that, the new road editing unit advances the sequence to step ST46. An example of the new road information generated through this process of step ST43 is shown in FIG. 16(a).

When, in above-mentioned step ST42, judging that there does not exist any reference point in the area at the predetermined distance d3 or less from the additional point X, as shown in FIG. 14(b), the new road editing unit defines two points P and Q on the new road which exist at the distance d3 from the additional point X as new reference points, and connects these two points P and Q with the additional point X to generate new new road information (step ST44). After that, the new road editing unit advances the sequence to step ST46. An example of the new road information generated through this process of step ST44 is shown in FIG. 16(b).

When, in above-mentioned step ST42, judging that there exists only one reference point B in the area at the predetermined distance d3 or less from the additional point X, as shown in FIG. 14(c), the new road editing unit selects, from among two points R and S on the new road in the area at the predetermined distance d3 from the additional point X, the point R at a longer distant from the reference point B in the area at the predetermined distance d3 or less from the additional point X, so as to define the point R as another point, and connects these reference point B, additional point X, and point R to generate new new road information (step ST45). After that, the new road editing unit advances the sequence to step ST46. An example of the new road information generated through this process of step ST45 is shown in FIG. 16(c).

In step ST46, the new road editing unit updates the new road information. More specifically, the new road editing unit 23 writes the new road information generated in either of steps ST43 to ST45 in the new road information storage unit 16b of the HDD 16 via the HDD access unit 17. When the new road editing unit 23 completes the process of writing the new road information, the new road editing unit 23 sends a request to update the road information to the road information updating unit 21, and the road information updating unit 21 updates the new road information by using the same method as that for use in the process performed in step ST16 of the new road detecting process of above-mentioned Embodiment 1.

In the above-mentioned point adding process, the map information processing apparatus adds only one point newly. As an alternative, the map information processing apparatus can be constructed in such a way as to add a plurality of points newly. Furthermore, the map information processing apparatus can be constructed in such a way as to, in the above-mentioned point adding process, automatically determine points which are to be connected to the additional point. As an alternative, the map information processing apparatus can be constructed in such a way as to enable the user to specify points which are to be connected to the additional point. In this case, the user specifies points which are to be connected to the additional point by using the input device 42. The coordinates of each of the points which are specified by this input device 42 and which are to be connected to the additional point are sent to the new road editing unit 23 via the input receiving unit 14. The input device 42 and the input receiving unit 14 which are used for the specification of points which are to be connected to the additional point correspond to a reference point to be connected specifying means of the present invention.

### (2-2) Point Deleting Process

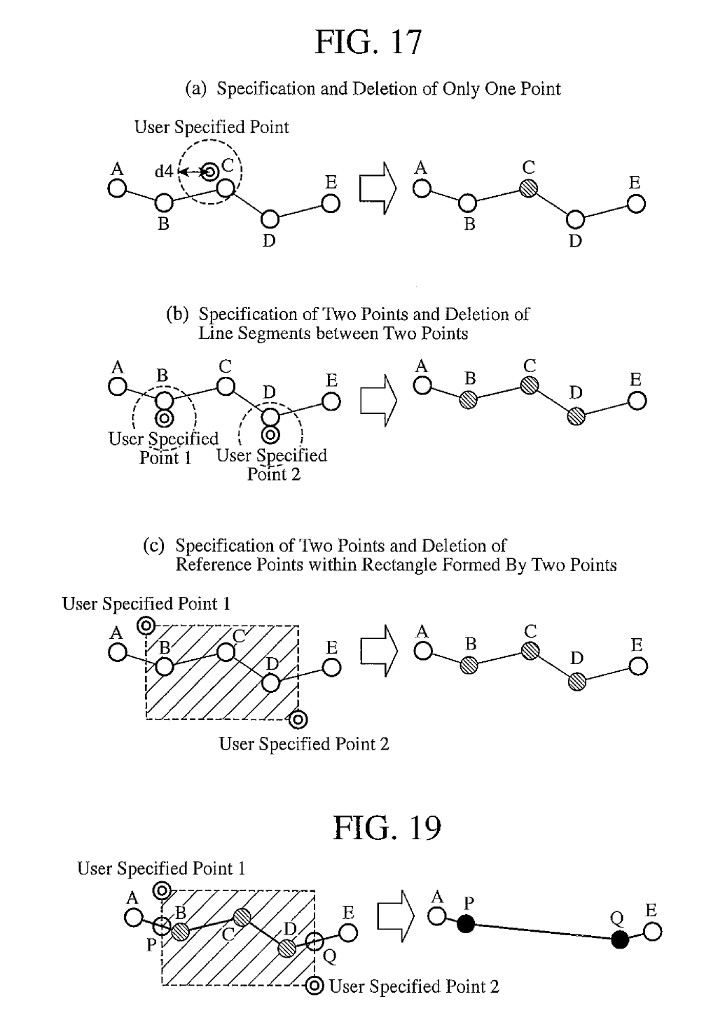

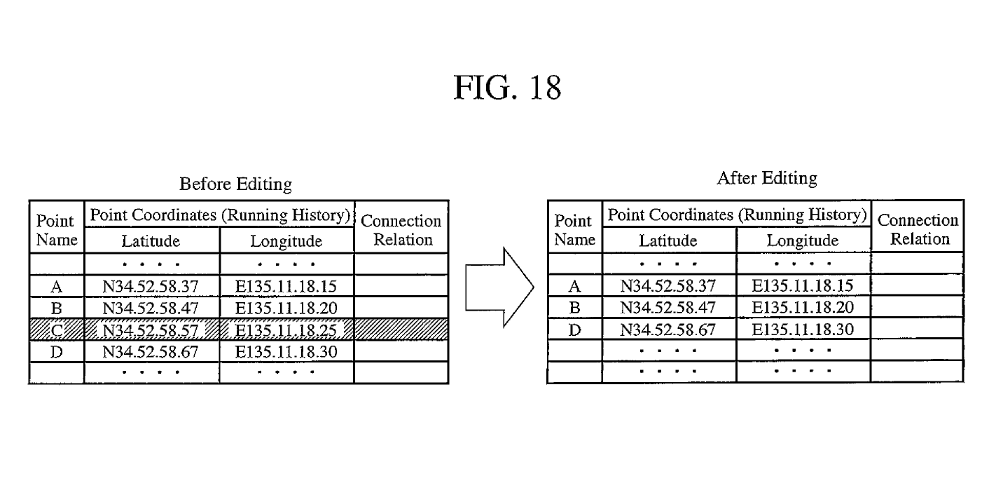

FIG. 17 is a view showing an image of the point deleting process of deleting the coordinates of a point on a new road. FIG. 18 is a view for explaining a change in the new road information which is caused by the point deleting process. Also when deleting the coordinates of a point on a new road, the map information processing apparatus can edit the new road by performing the update process of updating the new road information as shown in FIG. 18, like in the case of adding a point.

Hereafter, the point deleting process will be explained with reference to FIG. 17 focusing on a process of, when specifying a reference point which is an object to be deleted, selecting a candidate for the reference point to be deleted according to the user's input. A process of connecting points to update the new road information after deleting a reference point is the same as that in the case of the above-mentioned point adding process.

When deleting a point, the user specifies the point to be deleted by using the input device 42. The coordinates of the point to be deleted which is specified by this input device 42 are sent to the new road editing unit 23 via the input receiving unit 14. The input device 42 and the input receiving unit 14 which are used for the specification of the point to be deleted correspond to a reference point to be deleted specifying means of the present invention.

In this case, because it is difficult for the user to specify any reference point correctly, a reference point which exists in the vicinity of a point specified by the user is selected as a candidate for the reference point to be deleted. For example, as shown in FIG. 17(a), when only one point is specified by the user, a point C in the vicinity of the specified point is selected and deleted. Furthermore, as shown in FIG. 17(b), when two points are specified by the user, points B, C, and D included in line segments formed by the specified points B and D are selected as candidates for the reference point to be deleted. In addition, as shown in FIG. 17(c), the map information processing apparatus can be constructed in such a way as to select points included in a rectangle formed by two specified points as candidates for the reference point to be deleted.

Although not illustrated, the map information processing apparatus can be constructed in such a way as to inquire of the user whether to delete the coordinates of each of points which are objects to be deleted one by one, and delete the coordinates of all points which the user has instructed the map information processing apparatus to delete. Furthermore, the map information processing apparatus can be constructed in such a way as to, in the case as shown in FIG. 17(c), not only delete the points B, C, and D, but also add points at which the new road intersects the rectangle as new reference points, as shown in FIG. 19, so as to update the new road information.

### Embodiment 3

The map information processing apparatus in accordance with above-mentioned Embodiment 1 is constructed in such a way as to judge whether the movement destination of a point to be moved is on an existing road or at an intersection, though there can be a case in which the movement destination is on a high level road and a local street running in parallel with each other, and therefore the map information processing apparatus cannot judge to which one of them the point to be moved should be connected. In contrast, a map information processing apparatus in accordance with this Embodiment 3 is constructed in such a way as to, in such a case, inquire of the user to which one of a plurality of roads the point to be moved should be connected so as to select a candidate for the movement destination.

The structure of the map information processing apparatus in accordance with Embodiment 3 is the same as that of the map information processing apparatus in accordance with Embodiment 1 shown in FIG. 1. In the map information processing apparatus in accordance with Embodiment 2, the structure for implementing the new road editing process shown in FIG. 8 is used.

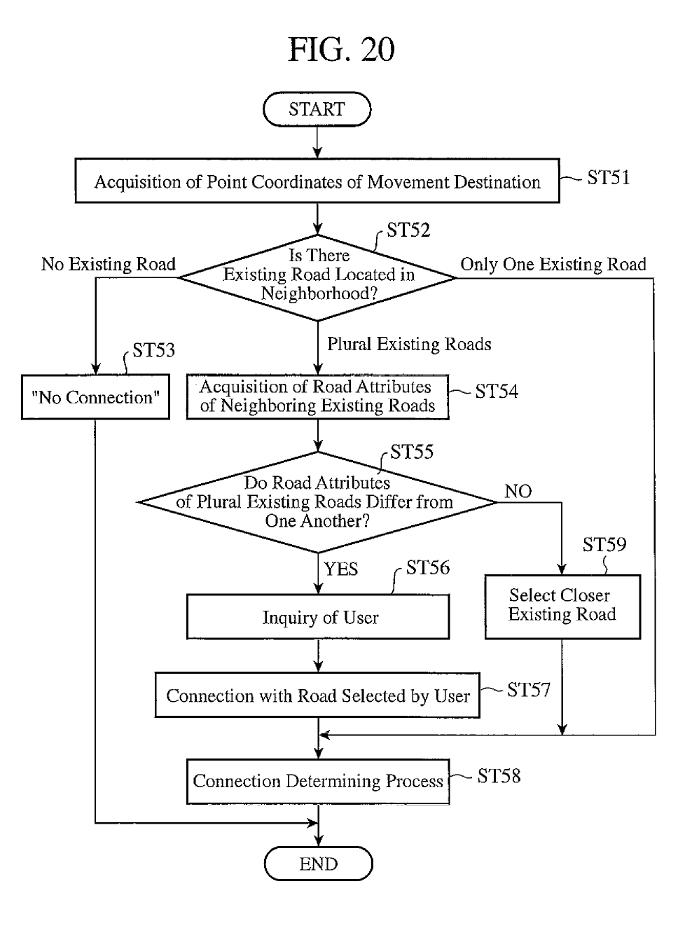

Next, the operation of the map information processing apparatus in accordance with Embodiment 3 will be explained with reference to a flow chart shown in FIG. 20. First, the map information processing apparatus acquires the coordinates of a point which is the movement destination (step ST51). The map information processing apparatus then checks to see whether there exists an existing road in the vicinity of the point (step ST52). When, in this step ST52, judging that no existing road exists in the vicinity of the point, the map information processing apparatus handles the point by judging that there is “no connection” (step ST53). When, in step ST52, judging that only one existing road exists in the vicinity of the point, the map information processing apparatus carries out a connection determination process (step ST58). This connection determination process is the same as that already explained with reference to FIGS. 6 and 7.

When, in above-mentioned step ST52, judging that a plurality of existing roads exist in the vicinity of the point, the map information processing apparatus then acquires the road attributes of each of the existing roads existing in the vicinity of the point (step ST54). As the road attributes of a road, information about the road's type, such as a highway, a toll road, a tunnel, or a bridge, and information showing the height of the road such as a high level road.

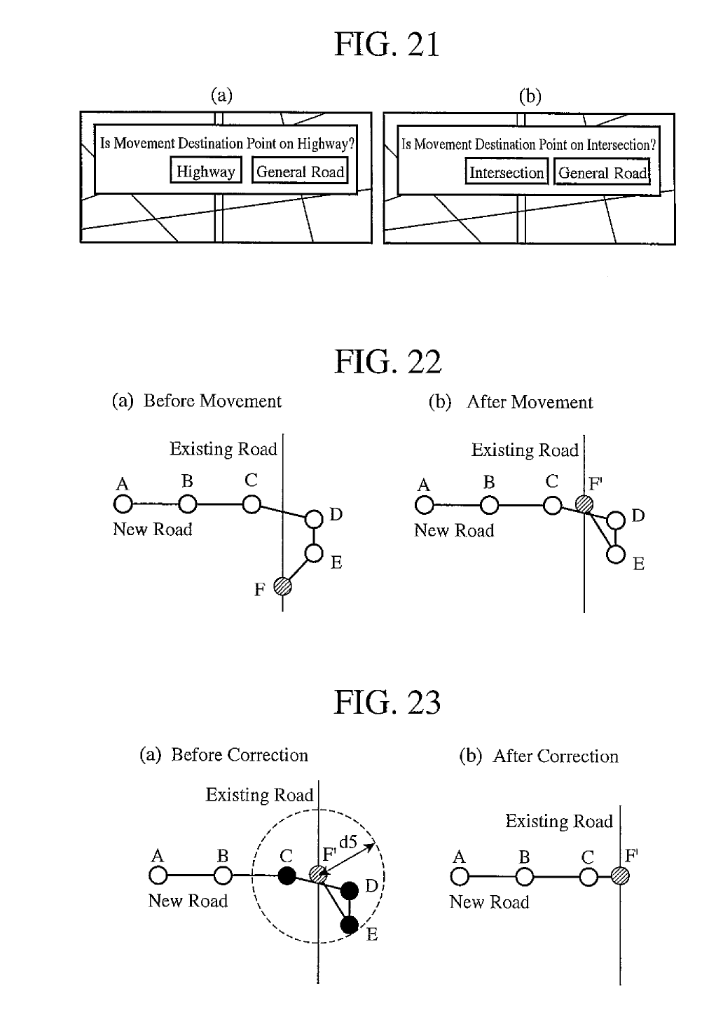

The map information processing apparatus then checks to see whether the road attributes of the plurality of existing roads acquired in step ST54 differ from one another (step ST55). When, in this step ST55, judging that the road attributes of the plurality of existing roads differ from one another, the map information processing apparatus then inquires of the user which one of them is the movement destination (step ST56). More specifically, the new road editing unit 23 sends data about a message showing the inquiry to the display controlling unit 12. The display controlling unit 12 converts the data about the message showing the inquiry sent from the new road editing unit 23 into data in a format which can be displayed by the display unit 40, and sends the data to the display unit 40. As a result, the message showing the inquiry, as shown in, for example, FIG. 21 is displayed on the display unit 40. The user specifies the movement destination by using the input device 42. For example, in the example shown in FIG. 21(a), the user specifies either a “highway” or a “general road,” whereas in the example shown in FIG. 21(b), the user specifies either an “intersection” or a “general road.” The data specified by the user with this input device 42 are sent to the new road editing unit 23 via the input receiving unit 14. The display controlling unit 12, the display unit 40, the input device 42, and the input receiving unit 14 which are used in order for the map information processing apparatus to make the inquiry to the user correspond to a user inquiring means of the present invention.

The map information processing apparatus then performs the process of connecting the point with the road selected by the user (step ST57). More specifically, the map information processing apparatus converts the point coordinates of the movement destination into the point coordinates of the reference point on the existing road which has been specified with the inquiry to the user. After that, the map information processing apparatus performs the connection determination process (step ST58). When, in above-mentioned step ST55, judging that the road attributes of the plurality of existing roads are the same as one another, the map information processing apparatus selects one of them which is the closest to the point (step ST59). After that, the map information processing apparatus advances the sequence to step ST58, and carries out the connection determination process.

The map information processing apparatus is constructed in such a way as to, in step ST59, select one of the plurality of existing roads which is the closest to the point. As an alternative, the map information processing apparatus can be constructed in such a way as to inquire of the user which one of the roads is to be selected. In this case, the map information processing apparatus expresses the plurality of existing roads which are candidates for an object to be connected with the point by displaying them in different colors, so that the user can easily distinguish among them.

Also in the case of each of the judgment of whether there exists an existing road, and the judgment about the vicinity of an intersection, which are explained with reference to FIGS. 6 and 7, the map information processing apparatus displays an inquiry message as shown in, for example, FIG. 21 on the display unit 40, to make an inquiry to the user, and handles the point according to the user's response.

### Embodiment 4

There can be a case in which a movement of only one reference point of a road causes the road to have an abnormal shape (a shape which cannot be considered actually), as shown in, for example, FIG. 22. The user is also able to correct the shape of the road by deleting some reference points, as explained in above-mentioned Embodiment 2, though the deletion is a troublesome operation for the user. To solve this problem, a map information processing apparatus in accordance with Embodiment 4 corrects the shape of a road automatically.

The structure of the map information processing apparatus in accordance with Embodiment 4 is the same as that of the map information processing apparatus in accordance with Embodiment 1 shown in FIG. 1. The map information processing apparatus in accordance with Embodiment 4 also uses the structure for implementing the new road editing process shown in the block diagram of FIG. 8, and carries out processes, such as a process of receiving an input from the user, and a process of producing a display of the shape of the corrected new road, by causing the components thereof to operate in cooperation with one another.

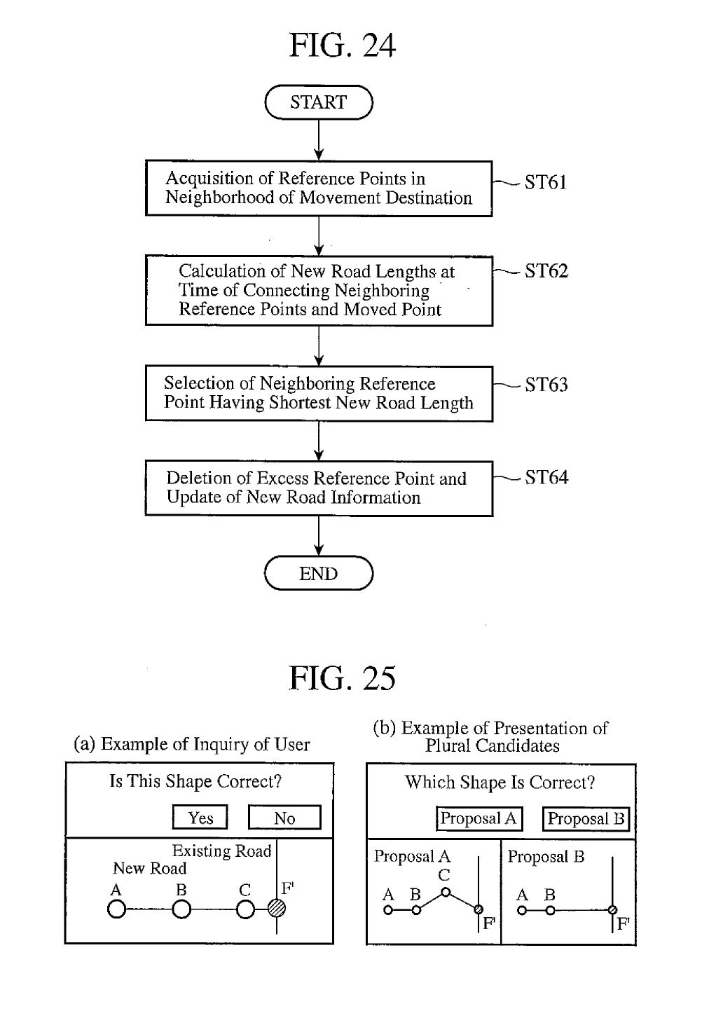

FIG. 23 is a view showing an image in which the map information processing apparatus corrects the shape of a road automatically by performing an automatic shape correcting process. FIG. 24 is a flow chart showing the automatic shape correcting process. Hereafter, the automatic shape correcting process will be explained with reference to these figures.

First, as explained in Embodiment 1, after moving a reference point, the map information processing apparatus acquires reference points located in the vicinity of a point F′ which is the movement destination of the reference point (in an area at a predetermined distance d5 or less from the point) (step ST61). In the example shown in FIG. 23, reference points C, D, and E are acquired. The length (new road length) of the new road in a case of connecting, in order, some of the reference points acquired in step ST61 with the point F′ which is the movement destination is calculated for each of the reference points located in the vicinity of the point F′ (step ST62). In the example shown in FIG. 23, three new road lengths including the length of line segments connecting the points A-B-C-F′, the length of line segments connecting the points A-B-C-D-F′, and the length of line segments connecting the points A-B-C-D-E-F′ are determined.

The reference point whose new road length is the shortest among the new road lengths determined in step ST62 is then selected (step ST63). In the example shown in FIG. 23, the point C is selected. The map information processing apparatus then performs a deletion of the excess reference points, and an update of the new road information (step ST64). More specifically, in order to define the line segments connecting the points A-B-C-F′ as the new road, the map information processing apparatus deletes the points D and E by using the method explained in Embodiment 2, and, after that, updates the new road information.

The map information processing apparatus in accordance with above-mentioned Embodiment 4 is constructed in such a way as to automatically select the reference point whose new road length is the shortest, just as it is. The map information processing apparatus can be alternatively constructed in such a way as to update the new road information after inquiring of the user about the validity of the shape of the road by using a screen as shown in, for example, FIG. 25(a). In this case, like the map information processing apparatus in accordance with Embodiment 3, the map information processing apparatus uses the display controlling unit 12, the display unit 40, the input device 42, and the input receiving unit 14 to make the inquiry to the user, and these components correspond to the user inquiring means of the present invention.

Furthermore, because the reference points located in the vicinity of the movement destination are made to differ by changing the predetermined distance d5 when acquiring the reference points located in the vicinity of the movement destination, the map information processing apparatus can determine a plurality of candidates for the shape correction in this case. Therefore, the map information processing apparatus can be constructed in such a way as to display, as candidates, different shapes according to the acquired reference points located in the vicinity of the movement destination on the display unit 40 to provide them for the user, and to enable the user to select a desired shape, as shown in, for example, FIG. 23(b). In this case, the display controlling unit 12, the display unit 40, the input device 42, and the input receiving unit 14 which are used for enabling the user to select a shape correspond to a shape selecting means of the present invention in the same way that they correspond to the above-mentioned user inquiring means.

### Embodiment 5

The map information processing apparatus in accordance with Embodiment 4 is constructed in such a way as to correct the shape of a new road automatically after moving a reference point. However, the shape of the road which is corrected automatically differs from that of the actual road. To solve this problem, a map information processing apparatus in accordance with Embodiment 5 is so constructed in such a way as to correct the shape of the new road after the vehicle has actually run along the new road.

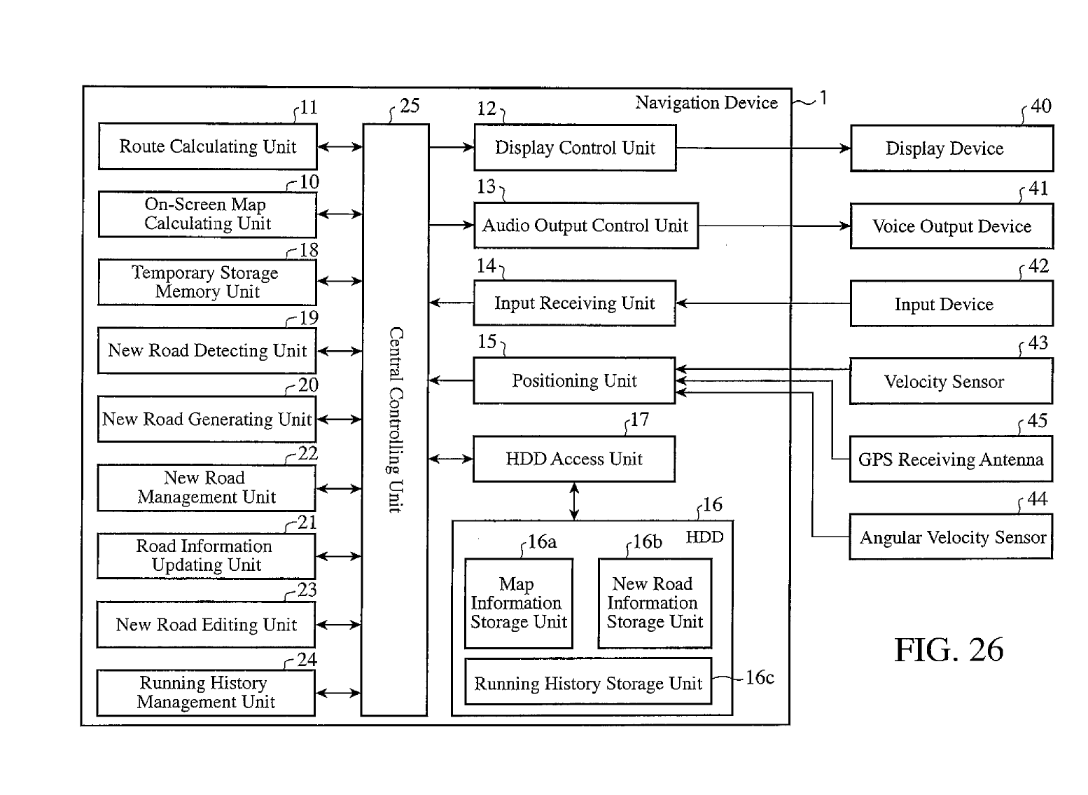

FIG. 26 is a block diagram showing the structure of the map information processing apparatus in accordance with Embodiment 5 of the present invention. This map information processing apparatus is constructed in such a way that a running history management unit 24 is added to the navigation device 1 of the map information processing apparatus in accordance with Embodiment 1, and a running history storage unit 16c is added to the HDD 16.

The running history storage unit 16c included in the HDD 16 stores, as a running history, the position information sent thereto via the HDD access unit 17 from the positioning unit 15. The running history management unit 24 manages the running histories stored in the running history storage unit 16c.

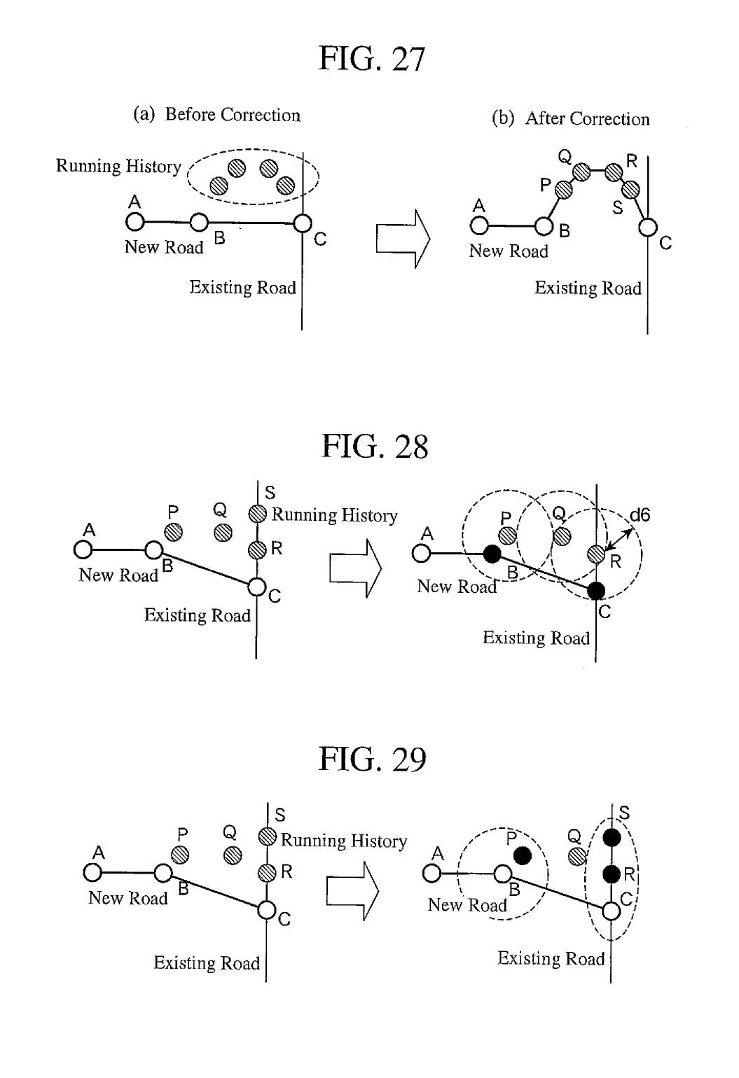

FIG. 27 is a view showing an image in which the map information processing apparatus corrects the shape of a new road according to the vehicle's running along the new road. Hereafter, the operation of the map information processing apparatus in accordance with Embodiment 5 of the present invention will be explained with reference to FIG. 27. When the new road editing unit 23 receives an instruction for correcting the shape of a new road from the input device 42, the new road editing unit 23 makes a request of the running history management unit 24 for a running history about the vehicle's running in the vicinity of the new road which is an object to be shape-corrected. The running history management unit 24 acquires the running history which the running history management unit has been requested from the running history storage unit 16c, and sends the running history to the new road editing unit 23.

From the received running history and the new road information about the new road which is an object to be shape-corrected, the new road editing unit 23 detects a portion in which the road shown by the running history has deviated from the new road (in FIG. 27(a), a portion enclosed by a dashed line) by using the same method as that for use in the new road detecting process of Embodiment 1, so as to add reference points properly by defining the portion in which the road shown by the running history has deviated from the new road as a shape correction part of the new road, and edits and updates the new road information by using the method shown in Embodiment 1 or Embodiment 2. As a result, as shown in FIG. 27(b), road information about the new road having a shape close to the actual road geometry can be acquired.

The map information processing apparatus in accordance with this Embodiment 5 is constructed in such a way as to use, as the trigger of the shape correction, an instruction from the input device 42. As an alternative, the map information processing apparatus can be constructed in such a way as to, when a predetermined or more number of running histories of the vehicle's running along the new road which is an object to be shape-corrected are stored therein, trigger itself to start the shape correction. The map information processing apparatus can be alternatively constructed in such a way as to, instead of using any running history, correct the shape of the new road by using the position information acquired from the positioning unit 15 when the vehicle has actually run along the new road, e.g., a section between points B and C as shown in FIG. 27.

### Embodiment 6

The map information processing apparatus in accordance with above-mentioned Embodiment 1 is constructed in such a way as to enable the user to select a reference point which is an object to be moved. In contrast, a map information processing apparatus in accordance with Embodiment 6 is constructed in such a way as to, by using a running history which is recorded after a new road is generated, estimate a candidate for the point to be moved of the new road and the point coordinates of the movement destination of the point.

The structure of the map information processing apparatus in accordance with Embodiment 6 is the same as that of the map information processing apparatus in accordance with Embodiment 5 shown in FIG. 26. Hereafter, the estimation process of estimating a reference point which is an object to be moved and the estimation process of estimating the point coordinates of the movement destination will be explained.

(3-1) Estimation Process of Estimating a Reference Point which is an Object to be Moved

FIG. 28 is a view showing an image of the estimation of a reference point which is an object to be moved. The map information processing apparatus selects points P, Q, and R as candidates for reference points of the new road from among the coordinates of points which are located in the vicinity of the new road and which are shown by the running history information (points connected with existing roads are also included in the reference points of the new road). The map information processing apparatus then estimates that reference points B and C which are located at a predetermined distance d6 or less from each of the points P, Q, and R are candidates for the reference point to be moved. The map information processing apparatus displays these estimated candidates for the reference point to be moved on the display unit 40. The user selects one of the candidates for the reference point to be moved which are displayed on the display unit 40. As a result, the map information processing apparatus moves the reference point selected by the user by using the method for use in the map information processing apparatus in accordance with Embodiment 1, and updates the new road information.

### (3-2) Estimation Process of Estimating the Point Coordinates of the Movement Destination

FIG. 29 is a view showing an image of the estimation of the point coordinates of the movement destination. When the user selects a point C (a point connected to an existing road), the new road editing unit 23 judges that the movement is the one of an end point, and then estimates that points R and S which are included in the points shown by the running history and which are also the ones on the existing road are candidates for the movement destination to provide these candidates for the user. The map information processing apparatus then moves the reference point C to the point selected by the user to update the new road information.

When the user selects a point B (a midway point on the new road), the new road editing unit 23 estimates that a point in the vicinity of the point B (a point at a predetermined distance or less from the point B) is a candidate for the movement destination to provide this candidate for the user. The map information processing apparatus then moves the reference point B to the point selected by the user to update the new road information.

As an alternative, the map information processing apparatus can be constructed in such a way as to estimate the movement destination of the reference point to be moved, the reference point to be moved being estimated by using the method shown in (3-1), by using the method shown in (3-2), and update the new road information.

### INDUSTRIAL APPLICABILITY

As mentioned above, because the map information processing apparatus in accordance with the present invention is constructed in such a way as to edit new road information which is generated on the basis of a detected new road and incorporate the new road information into the map information, the map information processing apparatus can produce a screen display of a correct map and can carry out a route guidance. Therefore, the map information processing apparatus in accordance with the present invention is suitable for use in a map information processing apparatus which is built in a vehicle-mounted navigation apparatus, and so on.

1. A map information processing apparatus comprising:
a position detecting means for detecting a position thereof;
a map information storage unit for storing map information including road information;
a new road detecting unit for, when information about a road corresponding to the position detected by said position detecting means does not exist in the road information acquired from said map information storage unit, detecting, as a new road, said road, and generating new road running history information showing a history of running along said detected new road;
a new road generating unit for generating new road information on a basis of the new road running history information generated by said new road detecting unit;
a new road information storage unit for storing the new road information generated by said new road generating unit;
a new road editing unit for editing new road information acquired from said new road information storage unit; and
a road information updating unit for updating the road information by adding the new road information edited by said new road editing unit to said map information storage unit.

2. The map information processing apparatus according to claim 1, characterized in that said map information processing apparatus includes: a reference-point-to-be-moved specifying means for specifying a reference point which is an object to be moved from among reference points which define the new road shown by the new road information acquired from the new road information storage unit; and a reference-point-to-be-moved coordinate specifying means for specifying point coordinates of a movement destination of the reference point specified by said reference-point-to-be-moved specifying means, and characterized in that the new road editing unit moves the reference point specified by said reference-point-to-be-moved specifying means to a position at the point coordinates specified by said reference-point-to-be-moved coordinate specifying means.

3. The map information processing apparatus according to claim 2, characterized in that the reference point specified by the reference-point-to-be-moved specifying means is a start point or an end point of the new road shown by the new road information.

4. The map information processing apparatus according to claim 2, characterized in that when judging that an existing road exists in a vicinity of the point coordinates specified by the reference-point-to-be-moved coordinate specifying means, the new road editing unit converts the point coordinates specified by said reference-point-to-be-moved coordinate specifying means into point coordinates of a reference point on the existing road in a vicinity of a point shown by said point coordinates.

5. The map information processing apparatus according to claim 2, characterized in that when judging that there is an intersection in a vicinity of the point coordinates specified by the reference-point-to-be-moved coordinate specifying means, the new road editing unit converts the point coordinates specified by said reference-point-to-be-moved coordinate specifying means into point coordinates at said intersection.

6. The map information processing apparatus according to claim 2, characterized in that said map information processing apparatus includes a running history storage unit for storing a running history, the new road editing unit estimates candidates for the reference point which is the object to be moved on a basis of the running history stored in said running history storage unit, and said reference-point-to-be-moved specifying means specifies the reference point which is the object to be moved from among said estimated candidates for the reference point.

7. The map information processing apparatus according to claim 2, characterized in that said map information processing apparatus includes a running history storage unit for storing a running history, the new road editing unit estimates candidates for the point coordinates which are the movement destination on a basis of the running history stored in said running history storage unit, and said reference-point-to-be-moved coordinate specifying means specifies the point coordinates of the reference point specified by the reference-point-to-be-moved specifying means from among said estimated candidates for the point coordinates.

8. The map information processing apparatus according to claim 1, characterized in that said map information processing apparatus includes an additional reference point specifying means for specifying a point to be added newly as a reference point which defines the new road shown by the new road information acquired from the new road information storage unit, and the new road editing unit generates the new road information including the reference point specified by said additional reference point specifying means.

9. The map information processing apparatus according to claim 8, characterized in that said map information processing apparatus includes a reference-point-to-be-connected specifying means for specifying another reference point which is to be connected to the reference point newly added through the specification by the additional reference point specifying means, and the new road editing unit generates the new road information including both the reference point specified by said additional reference point specifying means and the other reference point specified by said connected reference point specifying means.

10. The map information processing apparatus according to claim 1, characterized in that said map information processing apparatus includes a reference-point-to-be-deleted specifying means for specifying a reference point which is to be deleted from among the plurality of reference points which define the new road shown by the new road information acquired from the new road information storage unit, and the new road editing unit generates the new road information excluding the reference point which is deleted by said reference-point-to-be-deleted specifying means.

11. The map information processing apparatus according to claim 10, characterized in that the reference-point-to-be-deleted specifying means specifies a part of segments connecting the plurality of reference points which define the new road shown by the new road information acquired from the new road information storage unit so as to specify a reference point included in said segments as an object to be deleted.

12. The map information processing apparatus according to claim 10, characterized in that the reference-point-to-be-deleted specifying means specifies an area surrounding the plurality of reference points which define the new road shown by the new road information acquired from the new road information storage unit so as to specify a reference point included in said area as an object to be deleted.

13. The map information processing apparatus according to claim 8, characterized in that when judging that an existing road exists in a vicinity of the point coordinates specified by the additional reference point specifying means, the new road editing unit converts the point coordinates specified by said additional reference point specifying means into point coordinates of a reference point on the existing road which is nearest to a point shown by said specified point coordinates.

14. The map information processing apparatus according to claim 13, characterized in that said map information processing apparatus includes a user inquiring means for inquiring of a user whether or not the point coordinates specified by the additional reference point specifying means are those of a point on an existing road, and, when judging that an existing road exists in a vicinity of the point coordinates specified by said additional reference point specifying means and said user inquiring means has recognized that the point coordinates specified by the additional reference point specifying means are those of a point on an existing road, the new road editing unit converts the point coordinates specified by said additional reference point specifying means into point coordinates of a reference point on said recognized existing road.

15. The map information processing apparatus according to claim 8, characterized in that when judging that there is an intersection in a vicinity of the point coordinates specified by the additional reference point specifying means, the new road editing unit converts the point coordinates specified by said additional reference point specifying means into point coordinates at said intersection.

16. The map information processing apparatus according to claim 15, characterized in that said map information processing apparatus includes a user inquiring means for inquiring of a user whether or not the point coordinates specified by the additional reference point specifying means are those of an intersection, and, when judging that there is an intersection in a vicinity of the point coordinates specified by the additional reference point specifying means and said user inquiring means has recognized that the point coordinates specified by the additional reference point specifying means are those of an intersection, the new road editing unit converts the point coordinates specified by said additional reference point specifying means into point coordinates at said intersection.

17. The map information processing apparatus according to claim 13, characterized in that said map information processing apparatus includes a user inquiring means for, when a plurality of existing roads exist in a vicinity of the point coordinates specified by the additional reference point specifying means, inquiring of a user about road attributes of the plurality of existing roads, and the new road editing unit converts the point coordinates specified by said additional reference point specifying means into point coordinates of a reference point on an existing road having a road attribute recognized by said user inquiring means.

18. The map information processing apparatus according to claim 1, characterized in that the new road editing unit estimates a shape of the new road on a basis of the edited new road information, and the road information updating unit updates the road information by adding the new road information about the new road having the shape estimated by said new road editing unit to the map information storage unit.

19. The map information processing apparatus according to claim 18, characterized in that said map information processing apparatus includes a user inquiring means for inquiring of a user about validity of the shape of the new road estimated by the new road editing unit, and, when said user inquiring means has recognized that the shape of the new road has validity, the road information updating unit updates the road information by adding the new road information about the new road having the shape estimated by the new road editing unit to the map information storage unit.

20. The map information processing apparatus according to claim 18, characterized in that said map information processing apparatus includes a shape selecting means for selecting one shape from a plurality of shapes of the new road which are estimated by the new road editing unit, and the road information updating unit updates the road information by adding the new road information about the new road having the shape selected by the shape selecting means to the map information storage unit.

21. The map information processing apparatus according to claim 1, characterized in that when moving a new road through editing, the new road editing unit corrects the new road information about the new road on a basis of the position information detected by the position detecting means.
